(19) United States
(12) Patent Application Publication
(10) Pub. No.: US 2015/0289456 A1
(43) Pub. Date: Oct. 15, 2015

(54) HYDRAULIC ARRANGEMENT FOR A DELIMBER

(71) Applicant: Caterpillar Forest Products Inc., Peoria, IL (US)

(72) Inventor: John Cudoc, Phillips, WI (US)

(73) Assignee: Caterpillar Forest Products Inc., Peoria, IL (US)

(21) Appl. No.: 14/250,803

(22) Filed: Apr. 11, 2014

(51) Int. Cl. A01G 23/097

(52) U.S. Cl. CPC A01G 23/097

(57) ABSTRACT

A knuckleboom loader for processing trees includes a delimber, an actuator, and a hydraulic arrangement. The delimber includes a knife. The actuator is coupled to the knife and is operable to move the knife. The hydraulic arrangement includes a fluid, a tank, a pump, and a valving arrangement. The tank is configured to store the fluid. The pump is in fluid communication with the tank and is configured to supply fluid from the tank to the actuator. The valving arrangement is located between the pump and the actuator. The valving arrangement is operable to regulate a flow of fluid from the pump to the actuator, and from the actuator to the tank for opening and closing the knife relative to a trunk of a tree.

### TECHNICAL FIELD

The present disclosure relates to a delimber of a knuckleboom loader and more particularly to a hydraulic arrangement for a delimber of a knuckleboom loader.

### BACKGROUND

Knuckleboom loaders are used in forestry applications to process trees. Conventionally, knuckleboom loaders include a frame, a boom, a stick, and a grapple. One end of the boom is connected to the frame. The other end of the boom provides for connection with the stick. The grapple is located distally from the boom and connected at an opposing end of the stick. The boom and the stick allow positioning of the grapple relative to the frame while the grapple can be articulated about its connection with the stick. Further, the grapple may include one or more jaws that are operable to open or close while processing trees i.e., while picking or placing the trees from or at a specified location.

In some cases, the knuckleboom loaders are mounted on trailers and used in combination with delimbers. The delimbers have knives that remove branches from a trunk of a tree. The knuckleboom loaders typically include an accumulator and a pump therein. The accumulator is located between the pump and one or more actuators associated with the knives. During operation, the pump is driven by an engine of the knuckleboom loader. The pump charges the accumulator with pressurized fluid that can be used for moving the actuators to open and close the knives. However, when the engine and/or the pump is turned OFF, the accumulator may remain in the charged state and hence, continue to supply pressurized fluid into the actuators even after the engine and/or the pump has been turned OFF. This may cause the knives of the delimber to inadvertently close.

Some control systems have been developed in the past to control the operation of the actuators and/or the knives of the delimber. For example, U.S. Pat. No. 6,814,112 relates to a single-grip harvester head for felling and processing trees in which a controller controls the press-power of the knives on a tree. However, such control systems may not prevent the charged state of the accumulators i.e., after the engine and/or the pump being turned OFF, from inadvertently closing the knives. Moreover, use of previously known control systems in delimbers may cause the knives to grip the trunk of the tree and/or prevent free movement of the tree between the knives during the delimbing process. Therefore, the previously known control systems may be ineffective in operation besides being complicated and expensive to implement onto delimbers.

### SUMMARY

In one aspect, the present disclosure provides a knuckleboom loader for processing trees. The knuckleboom loader includes a delimber, an actuator, and a hydraulic arrangement. The delimber includes a knife. The actuator is coupled to the knife and is operable to move the knife. The hydraulic arrangement includes a fluid, a tank, a pump, and a valving arrangement. The tank is configured to store the fluid. The pump is in fluid communication with the tank and is configured to supply fluid from the tank to the actuator. The valving arrangement is located between the pump and the actuator. The valving arrangement is operable to regulate a flow of the fluid from the pump to the actuator, and from the actuator to the tank for opening and closing the knife relative to a trunk of a tree.

In another aspect, the present disclosure provides a delimbing system including a delimber, an actuator, a hydraulic arrangement, and a control module. The delimber includes a knife. The actuator is coupled to the knife and is operable to move the knife. The hydraulic arrangement includes a fluid, a tank, a pump, and a valving arrangement. The tank is configured to store the fluid. The pump is in fluid communication with the tank and is configured to supply fluid from the tank to the actuator. The pump is in fluid communication with the tank and is configured to supply fluid from the tank to the actuator. The valving arrangement is located between the pump and the actuator. The valving arrangement is operable to regulate a flow of the fluid from the pump to the actuator, and from the actuator to the tank. The control module is communicably coupled to the valving arrangement. The control module is configured to receive an input signal, and based on the input signal; command the valving arrangement for opening and closing the knife of the delimber relative to a trunk of a tree.

Other features and aspects of this disclosure will be apparent from the following description and the accompanying drawings.

### BRIEF DESCRIPTION OF THE DRAWINGS

FIG. 1 is a side perspective view of an exemplary knuckleboom loader showing a delimber and knives in which embodiments of the present disclosure can be implemented;

FIG. 2 is a diagrammatic representation of the knuckleboom loader showing the knives of the delimber in an open position;

FIG. 3 is a diagrammatic representation of the knuckleboom loader showing the knives of the delimber in a closed position;

FIG. 4 is a schematic representation of a hydraulic arrangement and an actuator associated with the knives of the delimber according to an exemplary embodiment of the present disclosure;

FIG. 5 is an exemplary embodiment of the hydraulic arrangement and actuators associated with the knives of the delimber; and

FIG. 6 is an exemplary embodiment of the hydraulic arrangement and actuators associated with the knives of the delimber.

### DETAILED DESCRIPTION

The present disclosure relates to a hydraulic arrangement for a knuckleboom loader equipped with a delimber. Wherever possible the same reference numbers will be used throughout the drawings to refer to same or like parts. Moreover, references to various elements described herein are made collectively or individually when there may be more than one element of the same type. However, such references are merely exemplary in nature. Accordingly, it may be noted that any such reference to elements in the singular is also to be construed to relate to the plural and vice-versa without limiting the scope of the disclosure to the exact number or type of such elements unless set forth explicitly in the appended claims.

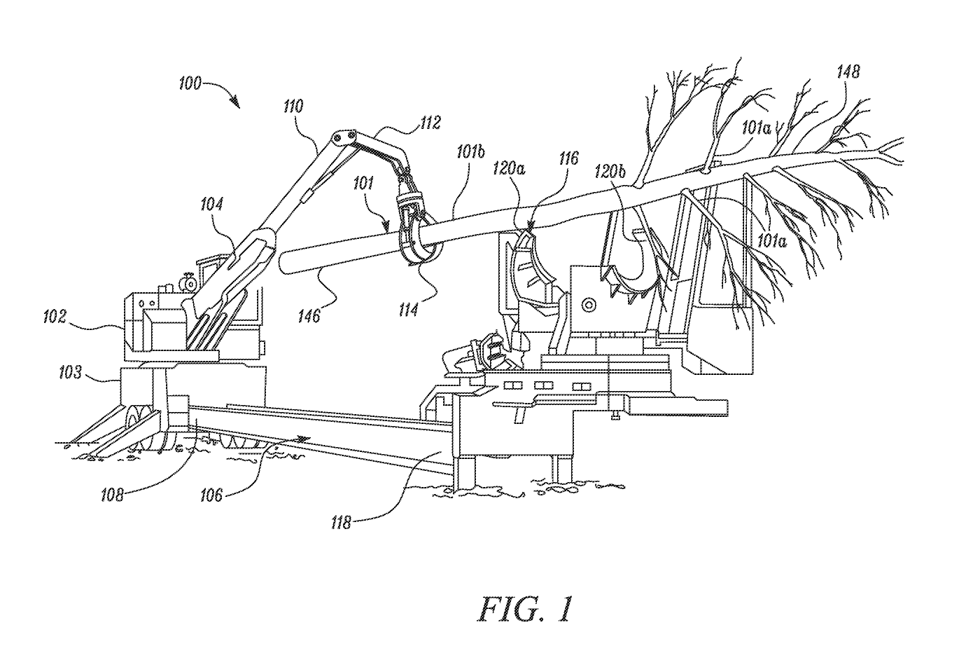

FIG. 1 shows a diagrammatic view of an exemplary knuckleboom loader 100 pivotally mounted on a frame 103 that is bolted onto a trailer 106. As illustrated in FIG. 1, the knuckleboom loader 100 is used to perform operations such as, but not limited to, hauling and loading of trees 101 that are felled by other machines.

The knuckleboom loader 100 includes a prime mover 102 and a cab 104 mounted on the frame 103. As shown in FIG. 1, the prime mover 102 and the cab 104 are mounted at a first end 108 of the trailer 106. The cab 104 is provided to house an operator of the knuckleboom loader 100. Moreover, the cab 104 includes control implements that are operable for controlling a working of the knuckleboom loader 100.

The prime mover 102 may be a fuel-based engine that powers the knuckleboom loader 100 by combustion of natural resources, such as gasoline, liquid natural gas, or other petroleum products. However, in alternative embodiments, the present disclosure may be equally implemented by way of using an electric motor in lieu of the engine.

The knuckleboom loader 100 further includes a boom 110, a stick 112, and a grapple 114 mounted in sequence to the frame 103. As such, the cab 104 and the boom 110 can be swiveled on top of the frame 103. Additionally, the boom 110 can be operated to pivot vertically with respect to the frame 103. The stick 112 can be vertically hoisted or lowered relative to the boom 110. The boom 110 and the stick 112 facilitate movement of the grapple 114 in various planes relative to the frame 103. Further, the grapple 114 can be articulated about its connection with the stick 112 thus, being capable of changing its orientation depending on specific requirements of an application. Therefore, the boom 110, the stick 112, and the grapple 114 impart dexterity to the knuckleboom loader 100 for executing operations such as loading and/or processing trees 101.

The knuckleboom loader 100 further includes a delimber 116 mounted at a second end 118 of the trailer 106. The delimber 116 includes a knife 120 (two knives 120a, 120b shown in the embodiment of FIG. 1). However, in alternative embodiments, more than two knives, for example, three, four, or five knives can be included in the delimber 116 depending on the type of delimber and/or specific requirements of an application. The knives 120a, 120b can be operated to open or shut against a trunk 101b of the tree 101 in accordance with the embodiments of the appended disclosure.

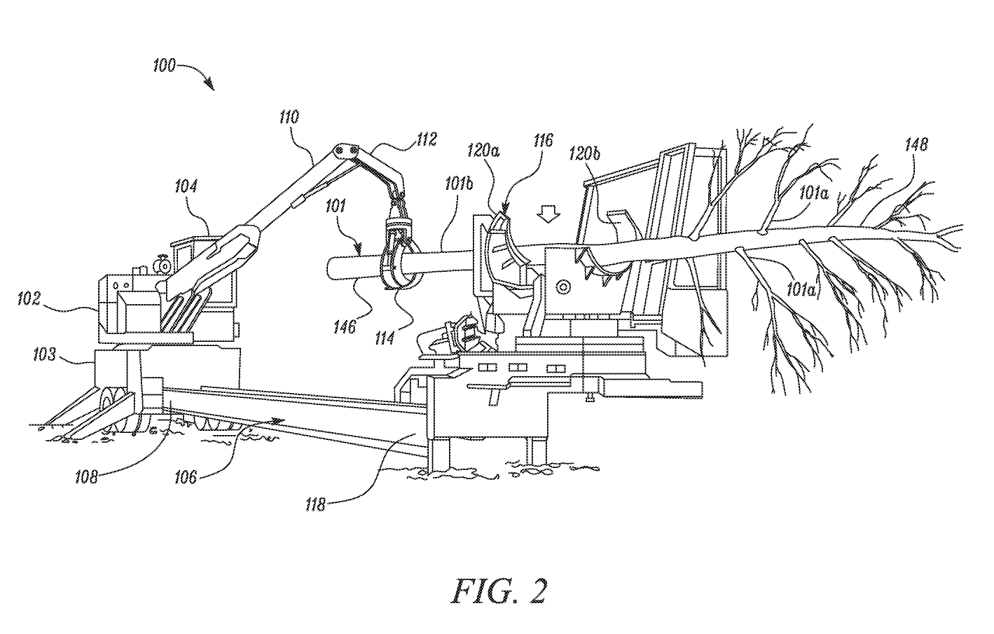

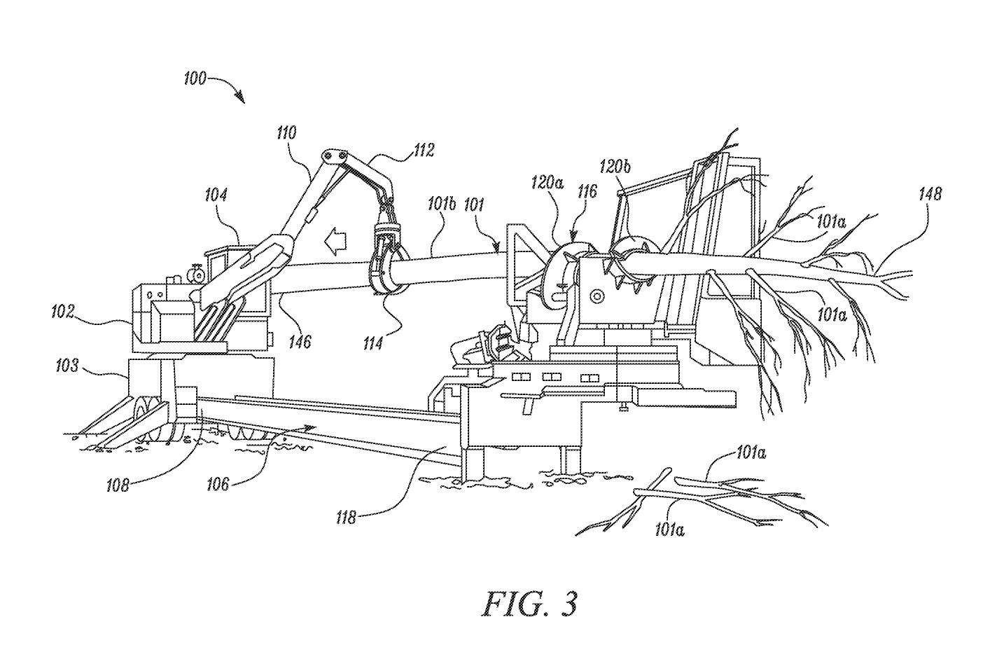

As depicted in FIG. 2, during operation, the knives 120a, 120b are opened, and the grapple 114 is used to place the felled tree 101 between the knives 120a, 120b. It should be noted that the grapple 114 continues to hold the trunk 101b of the tree 101 after placing it between the knives 120a, 120b. As depicted in FIG. 3, the knives 120a, 120b are shut against the trunk 101b of the tree 101. The grapple 114 is then used to pull the trees 101 through the closed knives 120a, 120b such that branches 101a of the tree 101 are severed and separated from the trunk 101b.

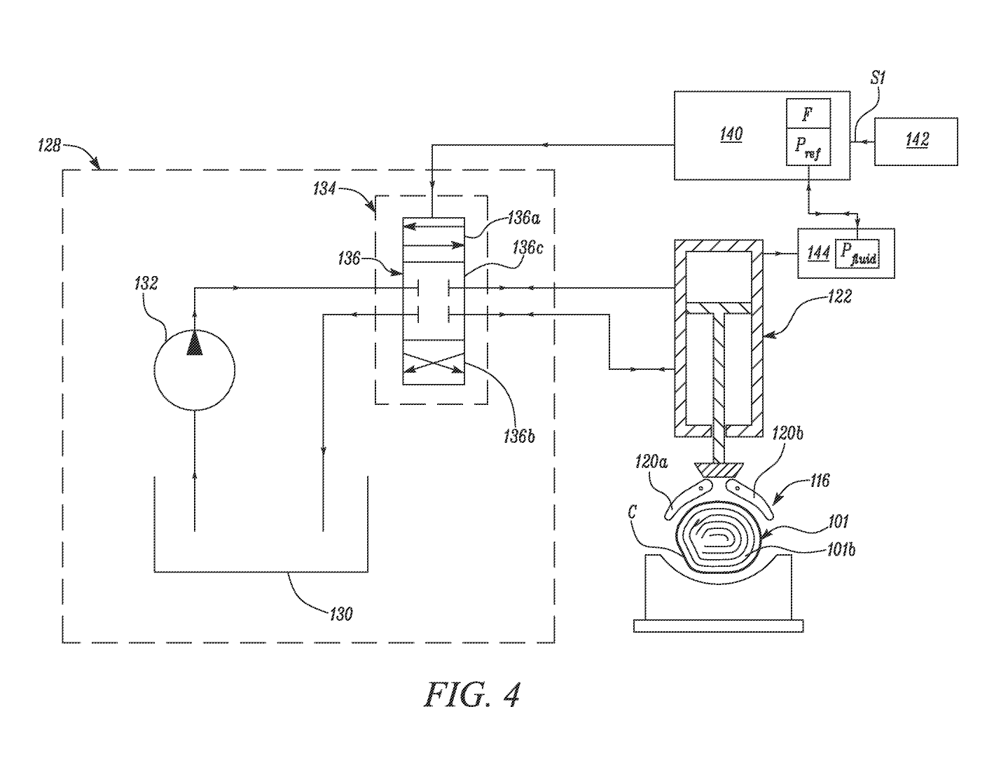

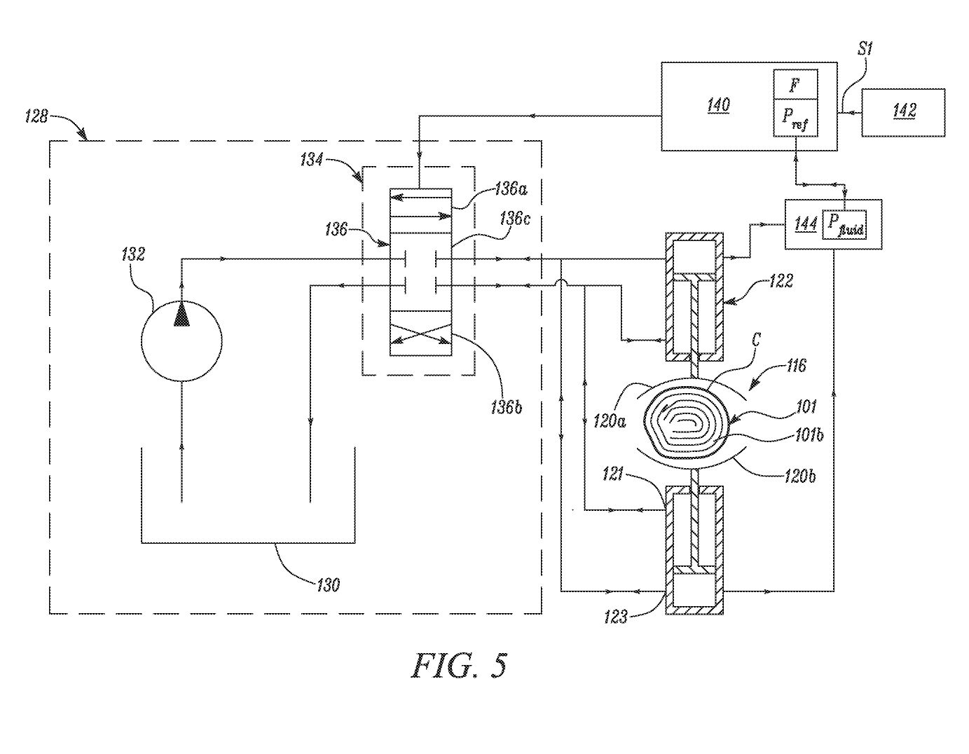

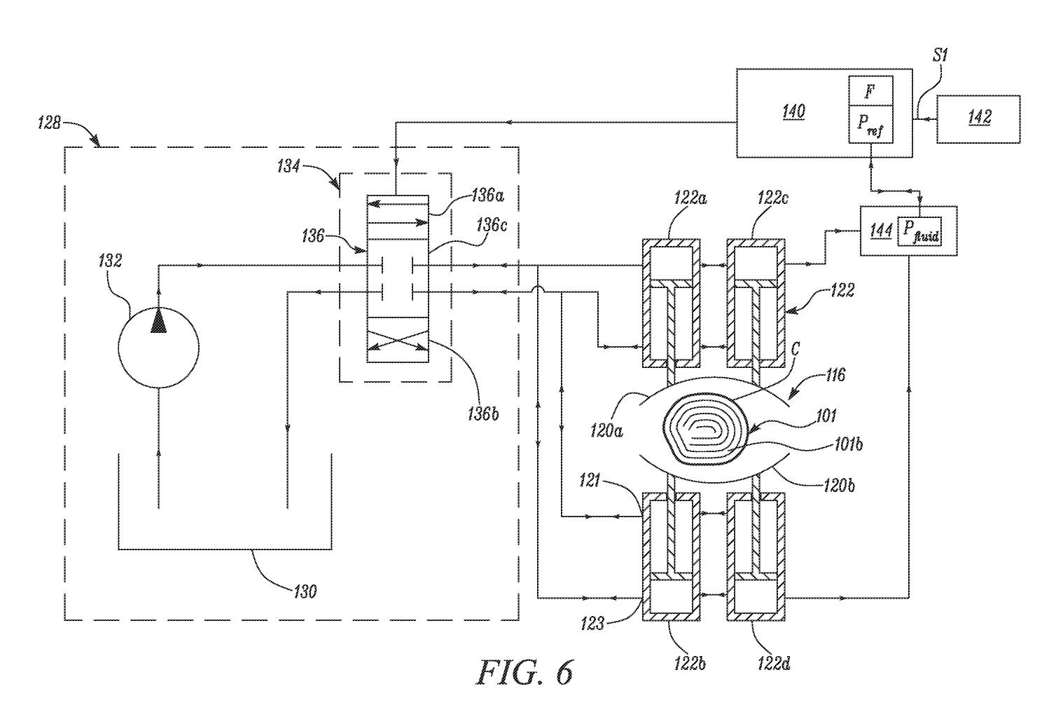

Referring now to FIG. 4, the knuckleboom loader 100 further includes an actuator 122 operatively coupled to the knives 120a, 120b of the delimber 116. The actuator 122 is operable to move the knives 120a, 120b relative to the trunk 101b of the tree 101. In an alternative embodiment as shown in FIG. 5, one actuator 122 can be associated with each knife 120a, 120b such that the number of actuators 122 corresponds to the number of knives 120a, 120b present in the delimber 116. Optionally, as shown in the embodiment of FIG. 6, more than one actuator 122 can also be implemented with each knife 120a, 120b of the delimber 116. Although various numbers of actuators and knives are described in conjunction with the schematics of FIGS. 4, 5, and 6, it is to be noted that such configurations of actuators and/or knives are merely exemplary in nature and non-limiting of the present disclosure. The number of knives and actuators used in a delimber can vary depending on various factors associated with an application such as, but not limited to, the type of delimber, an arrangement of linkages between the knives and the actuators of the delimber, a range of movement required by each of the knives, and space and/or cost constraints. Therefore, one of ordinary skill in the art will acknowledge that any number of actuators and/or knives may be used for implementation of the delimber 116 without deviating from the spirit of the present disclosure.

Turning back to FIG. 4, the knuckleboom loader 100 includes a hydraulic arrangement 128 disposed in fluid communication with the actuator 122. The hydraulic arrangement 128 includes a fluid, a tank 130, a pump 132, and a valving arrangement 134. The tank 130 is configured to store the fluid therein. The pump 132 is disposed in fluid communication with the tank 130. The pump 132 is operatively driven by the prime mover 102 of the knuckleboom loader 100. The pump 132 is configured to pressurize and supply fluid therefrom.

The valving arrangement 134 is located between the pump 132 and the actuator 122. The valving arrangement 134 is operable to regulate a flow of pressurized fluid from the pump 132 to the actuator 122, and from the actuator 122 to the tank 130 for moving the knives 120a, 120b relative to the trunk 101b of the tree 101

With reference to the specific embodiment of FIG. 4, the valving arrangement 134 includes a solenoid-operated four-way, three-position valve 136 (hereinafter simply referred to as “valve 136”). The valve 136 is disposed in fluid communication with the pump 132, the actuator 122, and the tank 130. Although the valve 136 is disclosed as a solenoid-operated four-way, three-position valve, it is to be noted that types and/or specific configurations of valves are merely exemplary in nature and non-limiting of this disclosure. In alternative embodiments, any type of valve commonly known in the art may be used in place of the solenoid-operated four-way, three-position valve to execute the functions of the valving arrangement 134 consistent with the present disclosure. Some examples of such valves may include, but are not limited to, check valves, ball valves, butterfly valves, needle valves, solenoid valves, gate valves, and the like. Moreover, any number of such valves may be used in place of the solenoid-operated four-way, three-position valve. For example, three check valves may be used in lieu of one solenoid-operated four-way, three-position valve.

The valve 136 is configured to allow pressurized fluid to be routed from the pump 132 to the actuator 122 in a first position 136a. Additionally, in this position, the valve 136 is also configured to allow fluid to be routed from the actuator 122 to the tank 130. As a result, the valve 136 causes the actuator 122 to extend and open the knives 120a, 120b.

However, when the valve 136 is moved into a second position 136b, pressurized fluid from the pump 132 can be routed to the actuator 122. Additionally, in the second position 136b, the valve 136 also allows fluid to be routed from the actuator 122 to the tank 130. Therefore, when in the second position 136b, the valve 136 may cause the actuator 122 to retract and effect a closing of the knives 120a, 120b.

Conversely, as shown in FIGS. 5 and 6, when one or more than one actuator 122a, 122b and/or 122c, 122d is associated with each of the knives 120a, 120b, extension of the respective actuators 122a, 122b and/or 122c, 122d can cause the knives 120a, 120b to close. Similarly, retraction of the respective actuators 122a, 122b and/or 122c, 122d can cause the knives 120a, 120b to open. Hence, one of ordinary skill will acknowledge that any order of movement can be executed in the knives 120a, 120b of the delimber 116 relative to the functioning of the actuators 122 depending on the configuration and/or number of knives 120 and actuators 122. Therefore, the schematics of FIGS. 4, 5 and 6 are merely exemplary and hence, non-limiting of this disclosure. Various other types of actuators, numbers, and/or arrangement of linkages between the actuators and the knives 120a, 120b may be implemented without limiting the scope of the present disclosure.

Turning back to FIG. 4, when the valve 136 is configured into a third position 136c, the valve 136 restricts fluid communication between the pump 132 and the actuator 122. In addition, the valve 136 also prevents fluid communication between the actuator 122 and the tank 130. Consequently, a certain volume of pressurized fluid is held constant at the actuator 122 to maintain a constant position of the actuator 122 (i.e., the actuator 122 remains stationary, or does not execute retraction or extension). The positions of the actuator 122 and the knives 120a, 120b are maintained constant unless the valve 136 is moved out of the third position 136c.

By implementing the third position 136c of the valve 136 after the first position 136a, the actuator 122 may be held in the extended state to cause the knives 120a, 120b to remain in a fully open position. Similarly, by moving the valve 136 into the third position 136c after the second position 136b, the actuator 122 may be held in the retracted state to maintain the knives 120a, 120b in the fully closed position. The third position 136c of the valve 136 can also be beneficially implemented after the valve 136 has been in the first or second positions 136a, 136b for a brief period of time such that the actuator 122 is held partway between the fully extended and fully retracted positions. Consequently, the knives 120a, 120b are also maintained in the partly open or partly closed condition. As such, the amount of extension or retraction of the actuator 122 may determine an extent of opening or closing of the knives 120a, 120b.

As shown in FIG. 4, the knuckleboom loader 100 further includes a control module 140 communicably coupled to the valving arrangement 134. The control module 140 is configured to receive an input signal S1 from a user-operable control 142 coupled thereto. The user-operable control 142 can be implemented as onboard equipment and located at the cab 104 of the knuckleboom loader 100 (refer to FIG. 1) for use by the operator. The user-operable control 142 may be any type of input device or control implement commonly known in the art. Some examples of input devices that can represent the user-operable control 142 may be, but are not limited to, control levers, panels with physical buttons or switches, or even a touch panel.

The operator may use the user-operable control 142 to command the control module 140 with the input signal S1. Based on the input signal S1, the control module 140 may change an operating state of the valving arrangement 134 to operatively open or close the knives 120a, 120b. For example, the operator may command the knives 120a, 120b of the delimber 116 to open by pressing a first switch on the user-operable control 142 and providing the control module 140 with the corresponding input signal S1. Similarly, the operator may command the knives 120a, 120b to be fully closed or simply maintained partway between the fully open and the fully closed positions via designated switches on the user-operable control 142.

As shown in FIG. 4, the control module 140 includes at least one sensor 144 coupled to the actuator 122. The sensor 144 disclosed herein may be, for example, a pressure transducer. The sensor 144 is operable to measure fluid pressure P_{fluid} in the actuator 122. The control module 140 is configured with a reference pressure P_{ref}. The reference pressure P_{ref} may be a pre-determined or maximum fluid pressure allowed within the actuator 122. The control module 140 is configured to compare the measured fluid pressure P_{fluid} with the reference pressure P_{ref}.

The control module 140 of the present disclosure is further configured to actuate the valving arrangement 134 and open the knives 120a, 120b of the delimber 116 if the measured fluid pressure P_{fluid} output by the sensor 144 is equal to the reference pressure P_{ref}. To perform the delimbing process smoothly, the measured fluid pressure P_{fluid} should ideally be less than or equal to the reference pressure P_{ref}. In an embodiment, the reference pressure P_{ref} may be set to a value corresponding to a “touch-up” position of the knives 120a, 120b i.e., a position at which the knives 120a, 120b merely make contact with the trunk 101b without applying clamping force to the trunk 101b. If the reference pressure P_{ref} is set at, for example, 10 psi (pounds per square inch), and if the measured fluid pressure P_{fluid} is less than the reference pressure P_{ref}, say, for example, at 8 psi, the control module 140 determines that the knives 120a, 120b should be closed further in order to establish the “touch-up” position with the trunk 101b. Hence, the control module 140 allows the valve 136 to remain in the first position 136a until the measured fluid pressure P_{fluid} is equal to the reference pressure P_{ref}.

When the measured fluid pressure P_{fluid} is equal to the reference pressure P_{ref}, i.e., for e.g. 10 psi, the control module 140 determines that the knives 120a, 120b are currently in the “touch-up” position with the trunk 101b. Upon such determination, the control module 140 may, in one embodiment, actuate the valve 136 into the first position 136a for a brief period of time. Actuating the valve 136 into the first position 136a causes the knives 120a, 120b to be re-opened away from the trunk 101b. Further, as the first position 136a of the valve 136 is implemented for a brief period of time, the knives 120a, 120b can travel only to be located marginally away from the trunk 101b i.e., proximate to the trunk 101b. For example, when the valve 136 is moved to the first position 136a for the brief period of time, the knives 120a, 120b can travel backwards to 95% of its forward-travel relative to the trunk 101b of the tree 101. The control module 140 may then command the valve 136 into the third position 136c such that the knives 120a, 120b are held proximate to the trunk 101b i.e., without any contact with the trunk 101b.

Alternatively, when the measured fluid pressure P_{fluid} is equal to the reference pressure P_{ref}, the control module 140 can optionally command the valve 136 to move directly into the third position 136a. Such movement of the valve 136 directly into the third position 136c can cause the knives 120a, 120b to be held in the “touch-up” position itself As such, in the “touch-up” position, the knives 120a, 120b can perform other additional and/or auxiliary functions such as, but not limited to, girdling and/or removing a bark of the tree 101. Therefore, the control module 140 of the present disclosure can either allow the knives 120a, 120b to be positioned close to the trunk 101b, or at the “touch-up” position with the trunk 101b depending on specific requirements of a logging application.

On the other hand, if the measured pressure P_{fluid} exceeds the reference pressure P_{ref}, the control module 140 determines that the knives 120a, 120b are clamping the trunk 101b with substantial force. For example, if the fluid pressure P_{fluid} at the actuator 122, as measured by the sensor 144, is found to be 12 psi or 13 psi, then the control module 140 determines from the excess fluid pressure P_{fluid} that the knives 120a, 120b are currently clamping the trunk 101b of the tree 101 and/or preventing the grapple 114 from executing a pull-through movement of the tree 101 between the knives 120a, 120b. In such cases, the control module 140 is additionally configured to actuate the valve 136 into the first position 136a for relieving fluid pressure in the actuator 122. In one embodiment, the relief in fluid pressure may be continued until the knives 120a, 120b are moved into the “touch-up” position i.e., in contact with the trunk 101b of the tree 101 without any clamping force. However, in another embodiment, the fluid pressure may be relieved until the knives 120a, 120b are opened and positioned marginally away from the trunk 101b of the tree 101 i.e., where the knives 120a, 120b are only positioned proximate to the trunk 101b of the tree 101 without any make contact thereto.

Although the sensor 144 is disclosed herein, one of ordinary skill in the art will acknowledge that it is possible to contemplate other suitable structures and/or methods in lieu of the sensor 144 for the sensing of fluid pressure P_{fluid}. Some suitable structures and/or methods that can be alternatively implemented may include mechanical structures and/or hydraulic methods, but is not limited thereto.

Further, it is common knowledge that trees come in a variety of sizes and shapes. Moreover, in softwood logging applications, i.e. pertaining mostly to wood from pine and fir trees, it has been seen that a circumference of the trunk 101b typically decreases upwards or reduces gradually from a base 146 to a top portion 148 of the trunk 101b, i.e., the base 146 of the trunk 101b typically has a larger circumference or girth as compared to a top portion 148 of the trunk 101b.

Keeping this in mind, the control module 140 of the present disclosure is additionally configured to determine if the measured fluid pressure P_{fluid} is equal to the reference pressure P_{ref} with a pre-specified frequency F as the tree 101 is being pulled between the knives 120a, 120b by the grapple 114. The value of pre-specified frequency F for executing such determination by the control module 140 may vary from one logging or harvesting application to another. In one embodiment, the control module 140 may be configured to receive the measured fluid pressure P_{fluid} and perform/repeat such determination with the reference pressure P_{ref} at intervals of 0.3 seconds. However, a person of ordinary skill in the art will be able to determine a suitable periodicity or frequency F for a given forestry application to allow proper functioning of the control module 140.

Optionally, it is also envisioned that as the tree 101 is being pulled by the grapple 114 between the knives 120a, 120b, the control module 140 may continuously (i.e., without any intermittency) determine if the measured fluid pressure P_{fluid} is equal to the reference pressure P_{ref}. Therefore, if the measured fluid pressure P_{fluid} at any instant of the delimbing process is equal to the reference pressure P_{ref,} the control module 140 triggers the actuator 122 via the valve 136 into a movement of extension or retraction such that the knives 120a, 120b are moved marginally away or into the “touch-up” position with respect to the trunk 101b of the tree 101.

The reference pressure P_{ref} is a value that is selected by a user or the manufacturer of the control module 140 depending on various factors of a logging application. Although the value of reference pressure P_{ref} can vary from one logging application to another, it is envisioned that the reference pressure P_{ref} could typically lie in the range of about 1 psi to 500 psi. However, for the purposes of understanding the present disclosure, the reference pressure P_{ref} at the control module 140 may be regarded as being set at 10 psi. Prior to delimbing, the tree 101 is placed between the knives 120a, 120b and the knives 120a, 120b are momentarily brought into contact with the trunk 101b of the tree 101 until the fluid pressure P_{fluid} in the actuator 122 is measured and found to be equal to the reference pressure P_{ref}. In doing so, the control module 140 affirmatively establishes that the knives 120a, 120b are in contact i.e., in the “touch-up” position with respect to the trunk 101b of the tree 101. Upon such determination, the control module 140 may, in one embodiment, command the actuator 122 to marginally open the knives 120a, 120b and hold the knives 120a, 120b at a position proximate to the trunk 101b of the tree 101. Alternatively, the control module 140 may command the actuator 122 to lock the knives 120a, 120b in the “touch-up” position itself. Therefore, the control module 140 prevents the fluid pressure P_{fluid} in the actuator 122 from exceeding the reference pressure P_{ref}. Consequently, the knives 120a, 120b are prevented from clasping, clamping, or gripping the trunk 101b of the tree 101 during the delimbing operation.

As the tree 101 is being pulled between the knives 120a, 120b, the knives 120a, 120b may encounter a progressively narrower circumference of the trunk 101b. Accordingly, the control module 140, on the basis of the pre-specified frequency F, may repeatedly dispose the knives 120a, 120b in relative movement with the trunk 101b of the tree 101. Each time, the control module 140 determines if the measured fluid pressure P_{fluid} is equal to the reference pressure P_{ref} i.e., for each contact made by the knives 120a, 120b with the trunk 101b. If the condition P_{fluid}=P_{ref} (i.e., 10 psi) is satisfied, then the control module 140 may hold the “touch-up” position or optionally effect an opening of the knives 120a, 120b to a position marginally away from the trunk 101b, for example, to about 90% or 95% of the total forward travel relative to the trunk 101b of the tree 101.

In an embodiment, the valving arrangement 134 is configured to additionally prevent inadvertent closure the knives 120a, 120b when the prime mover 102 and/or the pump 132 are moved to a non-operational state. The non-operational state, disclosed herein, may be an OFF state of the engine and/or the pump 132 that is accomplished by the operator physically turning them OFF. Additionally, the non-operational state may also include situations where a breakdown of the engine and/or the pump 132 has occurred thus rendering the engine and/or the pump 132 unfit for further operation. The control module 140 may receive diagnostic data and/or operational state signals from various components of the knuckleboom loader 100 via appropriate secondary sensors for commanding the valving arrangement 134 into position to prevent closure of the knives 120a, 120b. The secondary sensors, disclosed herein, may be communicably coupled to the control module 140. Any type of sensor commonly known in the art may be used as the secondary sensor.

Further, a person having ordinary skill in the art will appreciate that in various embodiments of the present disclosure, the control module 140 may be readily embodied in the form of an ECM (Electronic Control module) package or a Programmable Logic Control (PLC) package and may be easily implemented for use with the knuckleboom loader 100. The ECM or PLC, disclosed herein, may further include various associated system hardware and/or software components known in the art.

Furthermore, although the present disclosure discloses that the delimber 116 forms part of the knuckleboom loader 100, the delimber 116 can optionally form part of a stand-alone delimbing system. Moreover, such stand-alone delimbing system can additionally include the hydraulic arrangement 128 and the control module 140 of the present disclosure for actuating the knives 120a, 120b of the delimber 116. One of ordinary skill in the art will appreciate that the delimbing process may be beneficially implemented by way of using the stand-alone delimbing system depending on specific requirements of a forestry application. Therefore, various combinations of the parts disclosed herein may be contemplated and such combinations can be implemented without deviating from the spirit of the present disclosure.

### INDUSTRIAL APPLICABILITY

The delimber 116 of the present disclosure has applicability for implementation and use in industrial settings such as forestry, agriculture, construction and the like.

In some cases, the control module 140, disclosed herein, can be used to provide a controlled amount of clamping force by the knives 120a, 120b on the trunk 101b. In other cases, the control module 140 can altogether prevent the knives 120a, 120b from clamping, clasping, or gripping the tree 101 during the delimbing operation. Moreover, the control module 140 prevents the knives 120a, 120b from inadvertently closing when the engine and/or the pump is rendered into the non-operational state i.e., the OFF state. Although the valving arrangement 134 is configured to allow the knives 120a, 120b to intermittently make contact with the trunk 101b of the tree 101 i.e., until the the condition P_{fluid}=P_{ref} is satisfied, such function is used by the control module 140 to affirmatively establish that the knives 120a, 120b are in contact or the “touch-up” position with the trunk 101b of the tree 101. Upon such determination, the control module 140 may hold the knives 120a, 120b in the “touch-up” position or alternatively configure the valve 136 into the first position 136a momentarily until such time that the knives 120a, 120b open to a position marginally away from the trunk 101b of the tree 101. As disclosed earlier herein, the degree or extent of such marginal opening may vary from one logging application to another. As such, the control module 140 configures the valve 136 into the third position 136c to maintain the “touch-up” position or the marginally open position of the knives 120a, 120b relative to the trunk 101b of the tree 101. When the knives 120a, 120b are moved marginally away from the trunk 101b or into the “touch-up” position with the trunk 101b, branches 101a of the tree 101 can be severed closer to the trunk 101b.

With reference to the foregoing embodiments, the knives 120a, 120b are held in the marginally-open position or the “touch-up” position until the control module 140 repeats the process of determining whether P_{fluid}=P_{ref} at a subsequent location of the trunk 101b that is encountered from continuous movement of the tree 101 between the knives 120a, 120b. As disclosed earlier herein, the control module 140 may implement the pre-specified frequency F while repeatedly performing the process of determination of whether P_{fluid}=P_{ref}.

With the present valving arrangement 134 and valving strategy associated thereof, the knuckleboom loader 100 can pull trees 101 freely through the delimber 116 to accomplish effective delimbing of the branches 101a by the knives 120a, 120b present therein. With use of the present control module 140, the knives 120a, 120b can be positioned to severe the branches 101a of the tree 101 without clamping the trunk 101b of the tree 101. Therefore, the knives 120a, 120b of the delimber 116 tend to be less prone to abrasion with the trunk 101b and a service life of the knives 120a, 120b is prolonged.

Moreover, with implementation of the present valving strategy in the knuckleboom loader 100, the knives 120a, 120b are configured to open or, if previously open, continue to remain in such open state when the engine and/or the pump 132 are turned OFF. In addition to this, during any event of abnormality in components of the knuckleboom loader 100, the valving strategy as defined by the control module 140 together with the valving arrangement 134 can prevent the knives 120a, 120b from inadvertently shutting or closing.

Moreover, the present configuration of the hydraulic arrangement 128, the control module 140, and the valving arrangement 134 allow a manufacturer to do away with use of accumulators that were typically employed by previously known control systems. As a result, costs associated with manufacture and operation of the present knuckleboom loader 100 can be less than that incurred with use of previously known systems. Moreover, the present configuration allows manufacturers of knuckleboom loaders and delimbing systems to achieve improved functionality with use of minimal components.

Modifications to embodiments of the present disclosure described in the foregoing are possible without departing from the scope of the present disclosure as defined by the accompanying claims.

I claim:

1. A knuckleboom loader for processing trees, the knuckleboom loader comprising:
a delimber having a knife;
an actuator coupled to the knife, wherein the actuator is operable to move the knife; and
a hydraulic arrangement comprising:
a fluid;
a tank configured to store the fluid;
a pump in fluid communication with the tank, the pump configured to supply fluid from the tank to the actuator; and
a valving arrangement located between the pump and the actuator; wherein the valving arrangement is operable to regulate a flow of fluid from the pump to the actuator, and from the actuator to the tank for opening and closing the knife relative to a trunk of a tree.

2. The knuckleboom loader of claim 1 further comprising a control module communicably coupled to the valving arrangement, the control module configured to:
receive an input signal; and
command the valving arrangement based on the input signal for operatively opening and closing the knife of the delimber.

3. The knuckleboom loader of claim 2, wherein the control module includes a sensor coupled to the actuator, the sensor configured to measure fluid pressure in the actuator.

4. The knuckleboom loader of claim 3, wherein the control module is configured to compare the measured fluid pressure with a reference pressure.

5. The knuckleboom loader of claim 4, wherein the control module is configured to actuate the valving arrangement and open the knife if the measured fluid pressure is equal to the reference pressure.

6. The knuckleboom loader of claim 4, wherein the control module is configured to actuate the valving arrangement for relieving fluid pressure in the actuator if the measured fluid pressure exceeds the reference pressure.

7. The knuckleboom loader of claim 1, wherein the valving arrangement includes a solenoid-operated four-way, three-position valve.

8. A delimbing system comprising:
a delimber having a knife;
an actuator coupled to the knife, wherein the actuator is operable to move the knife; and
a hydraulic arrangement comprising:
a fluid;
a tank configured to store the fluid;
a pump in fluid communication with the tank, the pump configured to supply fluid from the tank to the actuator; and
a valving arrangement located between the pump and the actuator, wherein the valving arrangement is operable to regulate a flow of fluid from the pump to the actuator, and from the actuator to the tank; and
a control module communicably coupled to the valving arrangement, the control module configured to receive an input signal, and command the valving arrangement based on the input signal for opening and closing the knife of the delimber relative to a trunk of a tree.

9. The delimbing system of claim 8, wherein the control module includes a sensor coupled to the actuator, the sensor configured to measure fluid pressure in the actuator.

10. The delimbing system of claim 9, wherein the control module is configured to compare the measured fluid pressure with a reference pressure.

11. The delimbing system of claim 10, wherein the control module is configured to actuate the valving arrangement and open the knife with respect to the trunk of the tree if the measured fluid pressure is equal to the reference pressure.

12. The delimbing system of claim 10, wherein the control module is configured to actuate the valving arrangement for relieving fluid pressure in the actuator if the measured fluid pressure exceeds the reference pressure.

13. A knuckleboom loader comprising:
a delimber having a knife;
an actuator coupled to the knife, wherein the actuator is operable to move the knife;
a hydraulic arrangement comprising:
a fluid;
a tank configured to store the fluid;
a pump in fluid communication with the tank, the pump configured to supply fluid from the tank to the actuator; and
a valving arrangement located between the pump and the actuator; wherein the valving arrangement is operable to regulate a flow of fluid from the pump to the actuator, and from the actuator to the tank for opening and closing the knife; and
a control module communicably coupled to the valving arrangement.

14. The knuckleboom loader of claim 13, wherein the control module positions the valving arrangement in a first position to open the knife.

15. The knuckleboom loader of claim 13, wherein the control module positions the valving arrangement in a second position to close the knife.

16. The knuckleboom loader of claim 13, wherein the control module positions the valving arrangement in a third position to maintain a constant position of the knife.

17. The knuckleboom loader of claim 13, wherein the control module positions the knife against a trunk of a tree when a sensed pressure in the actuator is equal to a reference pressure.

18. The knuckleboom loader of claim 17, wherein the control module further moves the knife towards the trunk of the tree when the sensed pressure in the actuator is less than the reference pressure.

19. The knuckleboom loader of claim 18, wherein the control module further opens the knife away from the trunk of the tree when the sensed pressure in the actuator is greater than the reference pressure.

20. The knuckleboom loader of claim 19, wherein the sensed pressure is measured by a sensor communicably coupled to the actuator.
